(19) United States
(12) Patent Application Publication
(10) Pub. No.: US 2025/0130622 A1
(43) Pub. Date: Apr. 24, 2025

(54) RACK CONTROL

(71) Applicant: Natron Energy, Inc., Santa Clara, CA (US)

(72) Inventors: Gopalakrishnan Parakulam, Dublin, CA (US); Michael Shmukler, Sunnyvale, CA (US)

(73) Assignee: Natron Energy, Inc., Santa Clara, CA (US)

(21) Appl. No.: 18/671,438

(22) Filed: May 22, 2024

Related U.S. Application Data
(60) Provisional application No. 63/468,236, filed on May 22, 2023.
(60) Provisional application No. 63/468,243, filed on May 22, 2023.

(51) Int. Cl. G06F 1/3234; G06F 1/3206

(52) U.S. Cl. CPC G06F 1/3234; G06F 1/3206

(57) ABSTRACT

A system and method for providing state machine control of a short-term power bridging architecture, particularly tailored to improvements in electrochemical cell packs that include an aggregation of electrochemical cells having at least one electrode using a TMCCC. three sections, including: (a) a first section, a protection section managed by a Main Controller State Machine (MCSM); (b) a second section, a pack management section managed by a Follower State Machine (FSM); and (c) a third section, an interaction section in communication with the outside world managed by a Snooping State Machine (SSM).

### CROSS REFERENCE TO RELATED APPLICATIONS

This Application claims the benefit of U.S. Provisional Application 63/468,236 filed on May 22, 2023; This Application claims the benefit of U.S. Provisional Application 63/468,243filed on May 22, 2023; This application is related to U.S. application Ser. No. 18/671,012 (Attorney ocket 20295-7133 filed on even date herewith that claims benefit of U.S. Provisional Application 63/468,236), the contents of these applications are hereby expressly incorporated by reference thereto in their entireties for all purposes.

### FIELD OF THE INVENTION

The present invention relates generally to power delivery and power delivery management systems and methods, particularly power delivery systems including electrochemical cells including a coordination compound electrochemically active in one or more electrodes, and more specifically, but not exclusively, to improvement in architectures, controls, and implementations of power bridging solutions.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Applicant has developed improved electrochemical cells using transition metal cyanide coordination compounds (TMCCCs) in one or more electrode structures. These materials offer improved performance characteristics that may be incorporated into new and improved power and energy solutions. This application pertains primarily to improvements in power cell solutions, such as power bridging among other applications.

For some time, there has been an increasing demand for backup power, this demand has become a major issue for both consumers and electricians because voltage surges can bring an entire home or office to a standstill. There are often opportunities to bridge a downtime during a switching transition by supporting a critical energy load during a failing, transitioning, and/or starting power source, such as moving to a stable alternate source as quickly as possible. There are a range of bridging products in the marketplace, differentiated in part by the type of electrochemical cell/structure such as those that use lead-acid batteries, low-and high-speed flywheels and ultra capacitors, among others.

Lead-acid batteries are the cheapest and most popular option, but they have a shorter life-span than other alternatives for short-term storage. These batteries must be kept at 25 degrees Celsius because higher temperatures shorten their life and lower temperatures reduce the capacity. Lead-acid batteries should be stored in temperature-controlled environments to preserve the life of the battery.

Flywheels have a longer cycle life because power is provided from a primary source via an open transfer switch. Flywheels are charged and then discharged, using a generator. These units have enough stored power to encounter voltage sags and momentary service interruptions. Computer and manufacturing facilities may use flywheels to enable backup generators to be up and running within five to 10 seconds.

Ultra-capacitors, which can also be charged more quickly than batteries, are most popular for very short-term applications where voltage sags last only a few seconds. Although their initial cost may be about 10 times more than lead-acid batteries, their advantage is much greater, having a cycle life that is much better than lead-acid batteries, yielding about five times the power capability and longer life. Ultra-capacitors have a high tolerance for temperature and are more efficient during the charge/discharge cycle. A disadvantage of the ultra-capacitor is cost, but for short-term applications, they are cost competitive due to their higher power density.

There are uninterrupted power solutions (UPS) that may sometimes be used in some situations. This off-line or standby technology can be a cost-effective approach for small stand-alone applications like PCs and peripherals. With this type of unit, power comes directly from power mains (e.g., A/C outlet) until the voltage fails. When this happens, a battery-powered inverter turns on to continue the power supply while the UPS provides protection from surges.

Similar to a standby system, line-interactive technology provides power conditioning that can be effective to provide a UPS backup. But, unlike an off-line unit, line-interactive power condition may provide an automatic voltage boost when the power goes down, without accessing the batteries. In areas where power outages are infrequent, but there are often power fluctuations, such a system may be advantageous.

An on-line alternative may provide a very high level of power protection, conditioning and UPS available. Using double conversion technology, a UPS changes an incoming alternate current to direct current, then conditions it to eliminate noise or surges, and converts it to AC before it exits the UPS. Since the power runs continuously through the inverter, there is no transfer or switching time to battery mode in the event of a blackout.

UPSs may provide a “clean” source of power, eliminating noise that can cause interruptions in operations or data loss. They provide batteries for backup power to a system in the event of a power outage to enable time to safely save all open files and to shut down the system until normal power can be restored. Several hours of work can be lost due to a momentary brownout where the AC power supply slumps to a level under 100 volts, which can crash a computer before the work can be saved to a disk. Generally speaking, power surges often accompany brownouts as the power rebounds to normal. Brownouts often pass unnoticed when a UPS is used as part of a necessary power protection system.

Improvements in technologies coming to bridge the gap for standby power are desired. Older technologies included having a backup system with 15 to 30 minutes of battery time. Some solutions require some period, e.g., 15 or 30 seconds to start a backup/bridging generator, but there is a time in between where there is a gap. Most businesses are not operable without computers or other power consuming devices/equipment, and today they realize the need for power continuity across many use cases.

Fuel-free backup power systems are available and can be installed indoors, require low maintenance and produce no noise, smoke or emissions. A question for almost all businesses: when power terminates, planned or unexpected, would the business be able to continue to operate systems without interruption, particularly those that are critical to needs? Every hospital has a generator that will turn on when the electricity goes off, but they also require a backup power solution to bridge the 15- to 30-second gap needed to start the generator For those on life-support systems, this is obviously a critical situation. Business operations will not stop because of a power failure and valuable data is not lost.

With the increased use of local area networks, offices are becoming more and more susceptible to power issues. Because most files are stored on networks on one high-speed file server, a simple brownout could affect several users at a time. The recent increase in digital phone system use makes them vulnerable to power problems, as many businesses are now conducting all their business over the phone.

Even though no facility has perfect power quality, the electric company tries to supply homes and offices with a steady source of maximum current electricity. When the supply does not contain a stable voltage, frequency and source of maximum current, there is a power quality problem. Many people once believed that poor power quality has no cost as long as there are no obvious manifestations like breakers being tripped, equipment being burned or issues in production operations.

Poor power quality does affect electronic and motor loads, which can become damaged and create the largest cost to repair. Voltage and frequency variations can cause problems with both loads. A weak current limits these power loads, overheats an operation and leads to premature failure. Motors are the biggest victims of poor power quality. Once a motor fails, it is generally repaired or replaced but more often than not, the cause of the failure is not diagnosed. Because of poor power quality, the lifetime of a motor can be significantly reduced, for example lifetime cut in half.

Electric utilities have been monitoring their power lines for decades in an effort to prevent electrical disturbances. The result ensures compatibility between equipment and the electrical environment. Generators are generally not a complete solution to power interruptions. Some concerns mentioned above is that it takes time to start them and bring them online. There is a need to bridge that gap. Problems with traditional power bridging include systems that people believe are too expensive; they may replace batteries or implement no or insufficient solutions.

Only incandescent light bulbs and resistive heating elements demand perfect power while most other loads impose their own demands on the available electrical supply. Because of this, the demand of all inductive loads is for an unusual type of current. Resistive loads demand their current at the same time in each cycle, as the voltage is available.

Bridging power applications, stabilizing voltage and providing regulation for short-term energy solutions requires high-quality electric power. These systems with power bridging components use a fast-acting storage system to bridge the gap when slower starting, long-term systems are unable to do so. Short-term bridging power product availability may be improved and storage technologies that can provide immediate response with longer life are needed.

What may be beneficial is a system and method for providing state machine control of a short-term power bridging architecture, particularly tailored to improvements in electrochemical cell packs that include an aggregation of electrochemical cells having at least one electrode using a TMCCC.

### BRIEF SUMMARY OF THE INVENTION

Disclosed is a system and method for providing state machine control of a short-term power bridging architecture, particularly tailored to improvements in electrochemical cell packs that include an aggregation of electrochemical cells having at least one electrode using a TMCCC. The following summary of the invention is provided to facilitate an understanding of some of the technical features related to a new architecture and control for power bridging, and is not intended to be a full description of the present invention. A full appreciation of the various aspects of the invention can be gained by taking the entire specification, claims, drawings, and abstract as a whole. The present invention is applicable to other electrochemical cells having high power density in addition to TMCCC materials.

An embodiment may further include additional monitoring of the power rail, such as for safety monitoring to meet particular application requirements—however the control features remains the same.

An embodiment may further include an improvement in paralleling—for example an ability of embodiments to parallel multiple (e.g., two) racks easily with an appropriate interface boards.

An embodiment of the present invention may include an improved precharge capability—in an event that a pack falls very close to zero volts (within a predetermined threshold such as a below an Undervoltage threshold that may be set by a user or system), some embodiments of the present invention may be easily recovered through a disclosed precharge capability.

An embodiment of the present invention may include a black start capability—for example an ability of a system to bootstrap from its power to start up without any need or use of an external Vbus voltage to start the system.

An embodiment of the present invention may include a decoupling of a user from core functionality—a user interface board is provided that processes user interface functions with that processing decoupled from system functionality. In an example, an embodiment of a rack system may function without such a user interface board. The user interface board may provide enhanced features, such as for example, connecting two racks in parallel.

A bridging power architecture that supports a three-wire power transmission system that includes both voltage sensing and current sensing for both +Ve and −Ve paths.

A bridging power architecture that provides a greater facility to scale a number of power packs—for example, a number of packs that may be connected in series may be easily scaled from 1 to N, for example N≥2, such as N=8, 10, or 16. One reason for this facility is a separation of a control and power rail components: the control logic is not required to scale while the power rail components may be configured for increased possible maximum power. For example, a split bus option does not impact the control rail aspect.

An embodiment of the present invention for a rack architecture may include one or more of the following: (a) a rack architecture divided into a power path and a low voltage path. Elements disposed in the power path are sometimes referred to as protection elements and provide protection function; (b) rack architecture low voltage path is divided into a control section and an interface section wherein the control section provides a balance function and the interface section interfaces to devices outside the pack.

An embodiment of the present invention for a rack architecture may include one or more of the following: (a) a rack architecture divided into a power path and a low voltage path. Elements disposed in the power path are sometimes referred to as protection elements and provide protection function; (b) rack architecture low voltage path is divided into a control section and an interface section wherein the control section provides a balance function and the interface section interfaces to devices outside the pack.

An embodiment of the present invention may have three sections, including: (a) a first section, a protection section managed by a Main Controller State Machine (MCSM); (b) a second section, a pack management section managed by a Follower State Machine (FSM); (c) a third section, an interaction section in communication with the outside world managed by a Snooping State Machine (SSM).

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a representative secondary electrochemical cell schematic having one or more TMCCC electrodes disposed in contact with a cosolvent electrolyte as described herein;

FIG. 2 illustrates a rack architecture including one string;

FIG. 3 illustrates a recovery circuit;

FIG. 4 illustrates a rack architecture including a split string arrangement;

FIG. 5 illustrates a communication architecture for a rack including two strings in parallel using an interface unit;

FIG. 6 through FIG. 12 illustrate two sets of state machines; FIG. 6-FIG. 9 illustrate a first set that includes an explicit maintenance mode and FIG. 10-FIG. 12 illustrate a second set that omits an explicit reference to a maintenance mode;

FIG. 6 illustrates a first set main controller state machine;

FIG. 7 illustrates a first set maintenance state machine;

FIG. 8 illustrates a first set follower state machine;

FIG. 9 illustrates a first set snooping state machine;

FIG. 10 illustrates a second set main controller state machine;

FIG. 11 illustrates a second set follower state machine; and

FIG. 12 illustrates a second set snooping state machine.

### DETAILED DESCRIPTION OF THE INVENTION

Embodiments of the present invention provide a system and method optimizing electrochemical cell manufacturing by reducing commercialization costs, including reduction of electrolyte costs used in their manufacturing. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to certain embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

Described herein is a new class of power bridging rack architecture for use with power storage packs that include a set of electrochemical cells having electrodes that contain transition metal cyanide coordination compound (TMCCC) materials as electrochemically active materials.

An embodiment of the present invention for a rack architecture may include one or more of the following: (a) a rack architecture divided into a power path and a low voltage path. Elements disposed in the power path are sometimes referred to as protection elements and provide protection function; (b) rack architecture low voltage path is divided into a control section and an interface section wherein the control section provides a balance function and the interface section interfaces to devices.

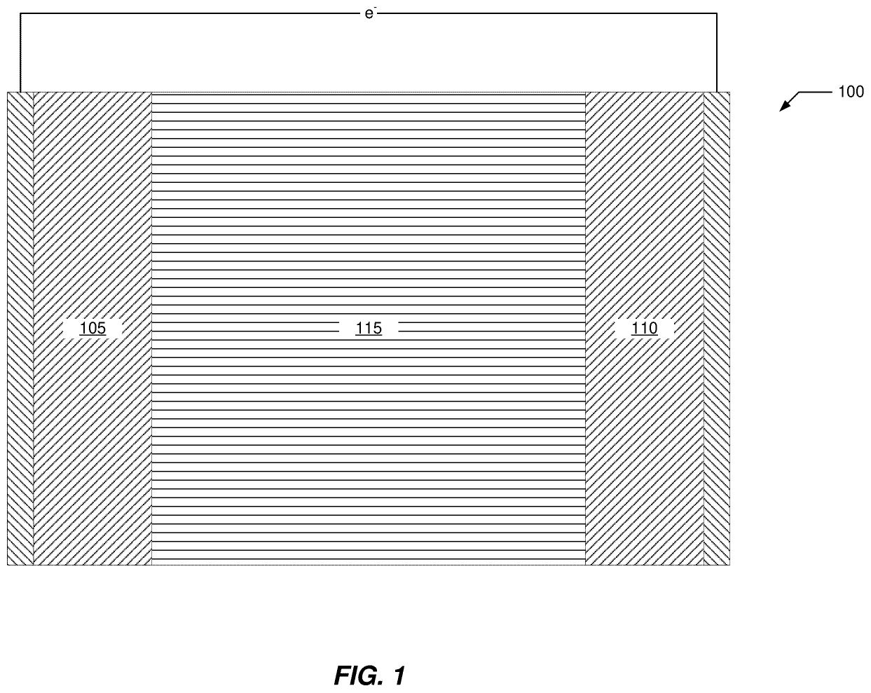

FIG. 1 illustrates a representative secondary electrochemical cell 100 schematic having one or more TMCCC electrodes disposed in contact with a cosolvent electrolyte as described herein. Cell 100 includes a negative electrode 105, a positive electrode 110 and an electrolyte 115 electrically communicated to the electrodes.

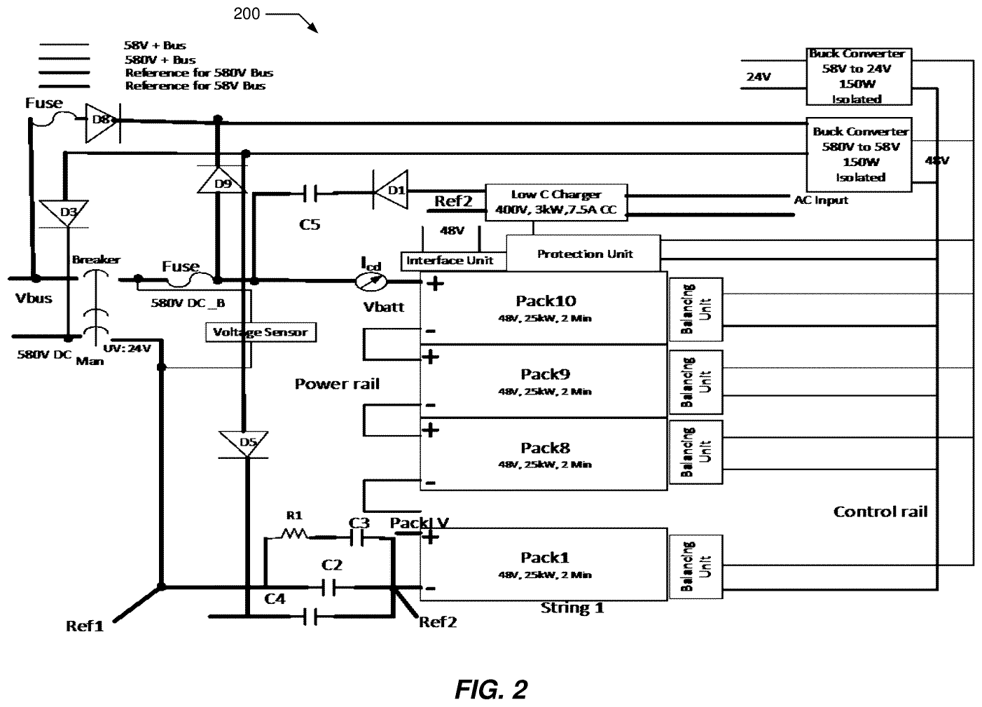

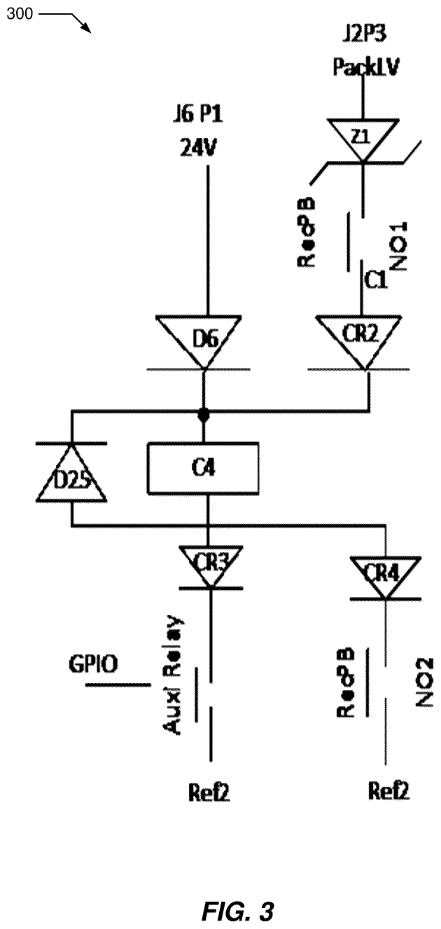

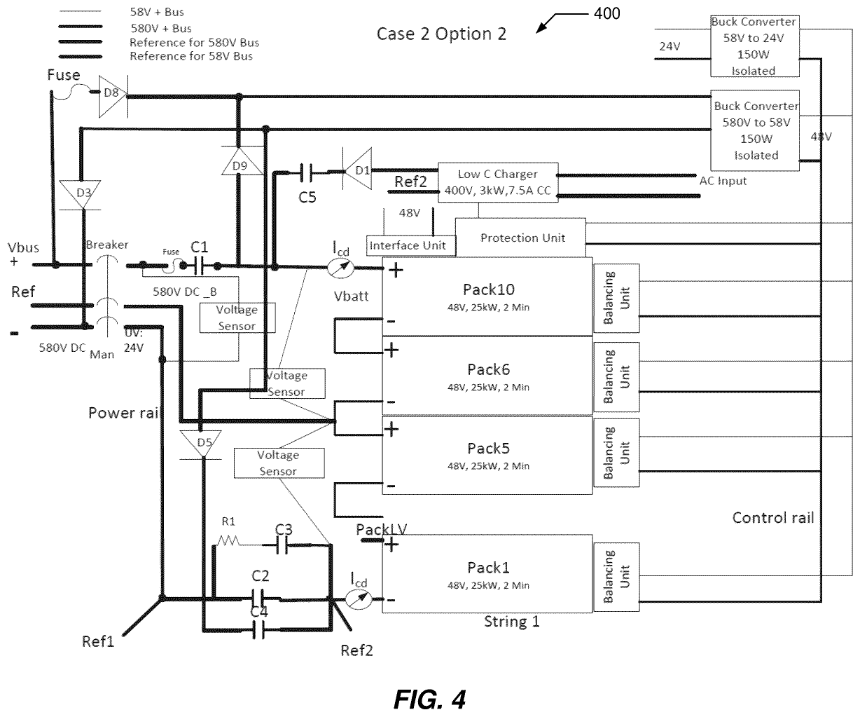

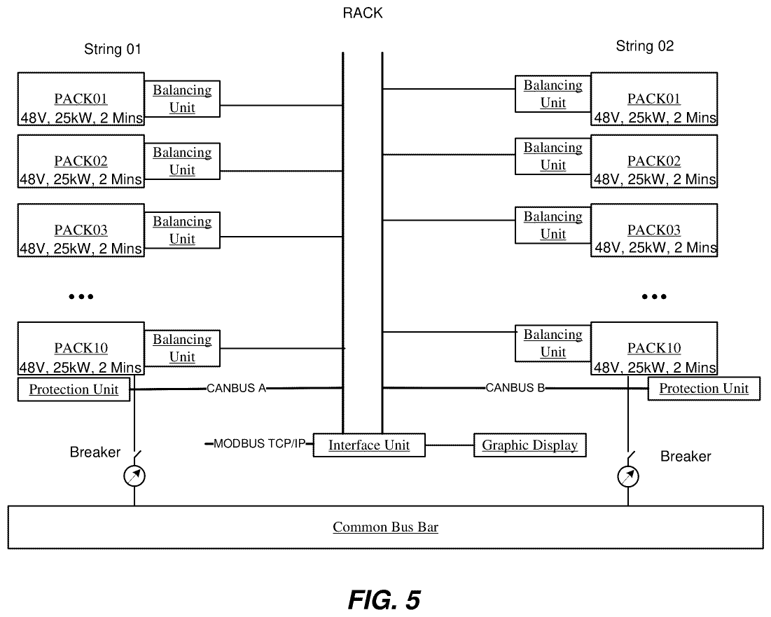

FIG. 2 illustrates a rack architecture one string; FIG. 3 illustrates a recovery circuit; FIG. 4 illustrates a rack architecture using a split string architecture; and FIG. 5 illustrates a communication architecture for a rack having two strings in parallel using an interface unit.

As illustrated in FIG. 2-FIG. 5, a rack architecture may include one or more strings of power storage devices, a split string arrangement, and an architecture including strings connected in parallel using an interface unit, each string may include one or more power storage packs connected in series. Each string may also include a protection board with protection elements. Such protection elements may include a set of contactors, fuse(s), temperature sensor(s), current sensor(s) and/or voltage sensor(s). FIG. 5 illustrates two rack systems connected in parallel. Paralleling of two, or more, rack systems is enabled by the snooping state machine described herein.

FIG. 2 and FIG. 4 illustrates ten power storage packs, each pack including a balancing unit powered by buck converters providing 58V (powered from 580V-150 W isolated) and 24V (powered from 58V-150 W isolated) using a control rail to each associated balancing unit. An input to the string of ten packs is provided from a low C Precharge (400V, 3 kW, 7.5 A CC) from AC input. Each pack is characterized as 48V, 25 kW, and 2 Min. FIG. 2 illustrates a two-wire power transmission system while FIG. 4 illustrates a three-wire power transmission system with a split string arrangement, and further includes voltage sensing and current sensing for both +Ve and −Ve legs. Split string terminology continues to change and is sometimes alternatively referred to as split bus or split rail. In FIG. 4, mid power packs 5 and 6 include a neutral wire pulled out and broken through the breaker. These modifications are included in the power rail and therefore have no impact on the control rail.

FIG. 5 illustrates a communication architecture, two strings of ten power storage packs each. A bus bar is communicated to pack 10 of each string through a breaker. An interface unit communicates to each string through CAN buses (CANBus A to string 1 and CANBus B to string 2). Each string includes a protection unit also communicated on its associated CAN bus. The interface unit is illustrated as communicating via a graphic display and implements a MODBUS TCP/IP.

The protection board implementing the protection elements may control flow of current into the power storage packs. The protection board in sync with the balance board may control the flow of current into the power storage packs. The protection board monitors the temperature and may control the flow of current into the power storage packs. The protection board may control the amount of current into the power storage packs by monitoring a voltage status of the power storage packs.

The protection board communicates with the power storage packs through a controller area network (CAN) bus that provides a physical and data link layer (OSI). An amount of current to flow through the power storage packs determines when a pre-charge (low C charger) circuit is to be turned ON or whether/when to turn ON contactors C1 and/or C2 to charge the associate power storage pack with high current through a 580V DC bus.

The rack architecture may include two sections: (a) a first section including a high voltage section and (b) a second section including a low voltage section. The high voltage section is powered through a power rail and the low voltage section is powered through a control rail. The control rail is generated by an isolated buck converter which derives power from the power rail, powered in this example by the 580V DC bus.

An embodiment of the rack architecture may include two (or more) power storage strings, each with a dedicated protection unit, packs, and protection elements.

Short circuit protection of a rack implementing an embodiment of the disclosed architecture may be accomplished as follows: (i) when a short circuit happens, the fuse opens first; (ii) when there is an issue with the fuse opening, then the breaker opens second; and (iii) a firmware control of the contactors happens third to open the contactors in any event where the fuse or the breaker do not isolate the circuit.

Each individual power storage pack may also include a set of fuses. In an event when everything fails, then these fuses of a power storage pack will open to prevent damage to the electrochemical cells of the power storage pack.

An embodiment of the present invention for the rack architecture may also include recovery faults hardware. When a state machine (as further described herein) enters a fault state, Contactor C4 is closed and Contactor C2 is opened. This helps to maintain power to the control circuitry while disconnecting a power path. To reduce power drain on the electrochemical cells, the state machine may turn itself off by opening C4.

A recovery push button may be added to turn ON the system without external power. This circuitry routes power from one of the power storage packs to turn the circuitry.

An embodiment of the present invention may include one or more state machines, such as a protection board state machine, a balance board state machine, and an interface board state machine.

The protection board state machine may sometimes be referred to as a main controller state machine. The main controller state machine kick starts the whole rack system. This main controller state machine determines a state of the rack by monitoring the power storage packs in the strings of the system. The main controller state machine decides, based on the information provided by the power storage packs, for example monitoring a string voltage whether the system enters one of a charge mode, a precharge mode, or a discharge mode.

The balance board state machine may sometimes be referred to as a follower state machine. Each follower state machine follows the main controller state machine. A balancing state in any follower state machine is one that deviates from the state of the main controller state machine.

The interface board state machine may sometimes be referred to as a snooping state machine. The snooping state machine monitors the data traffic on the CAN bus and captures the data for further processing by a section, state machine, or outside world.

Described herein are sets of state machines for the architecture of FIG. 1-5. These state machines may be adapted for other architectural configurations than those illustrated herein. These state machines are defined broadly in two different configurations: a first set having an explicit maintenance mode and a second set without an explicit maintenance mode.

### State Machine Set ONE (Explicit Maintenance Mode):

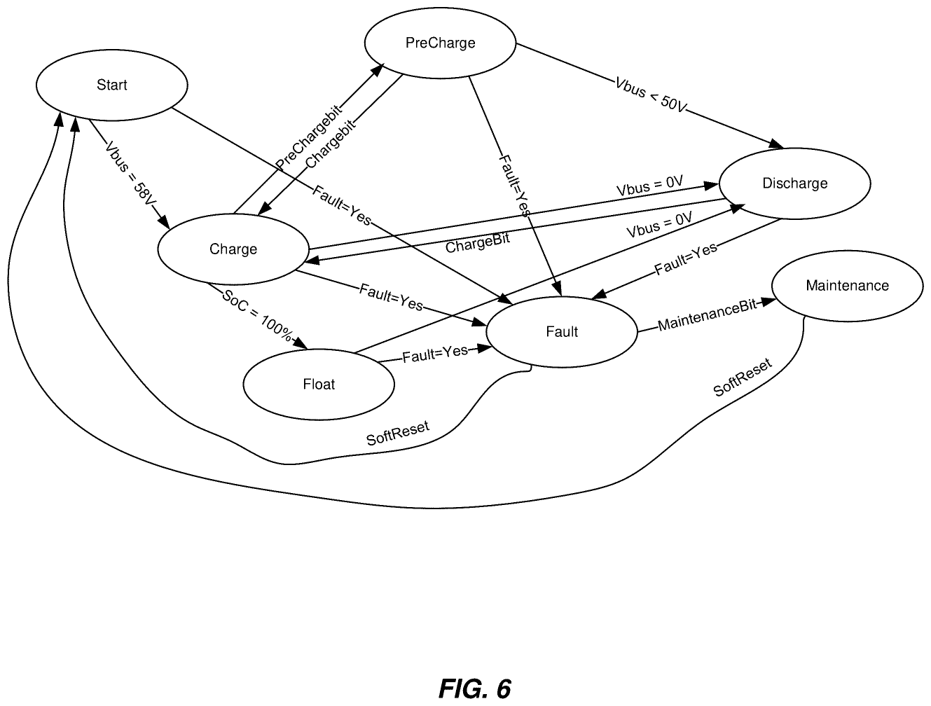

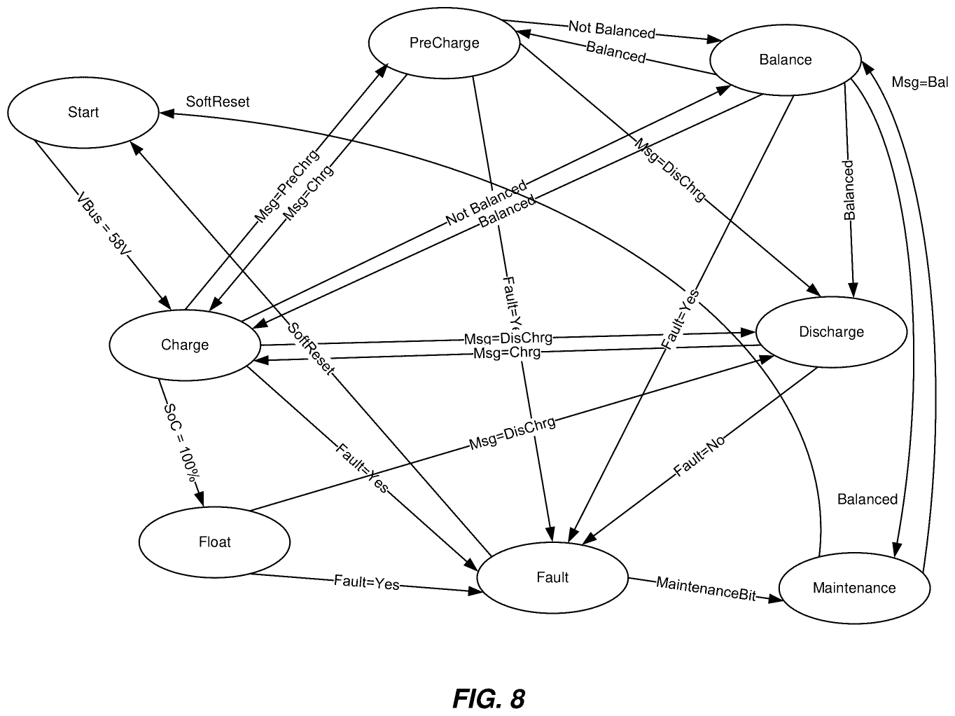

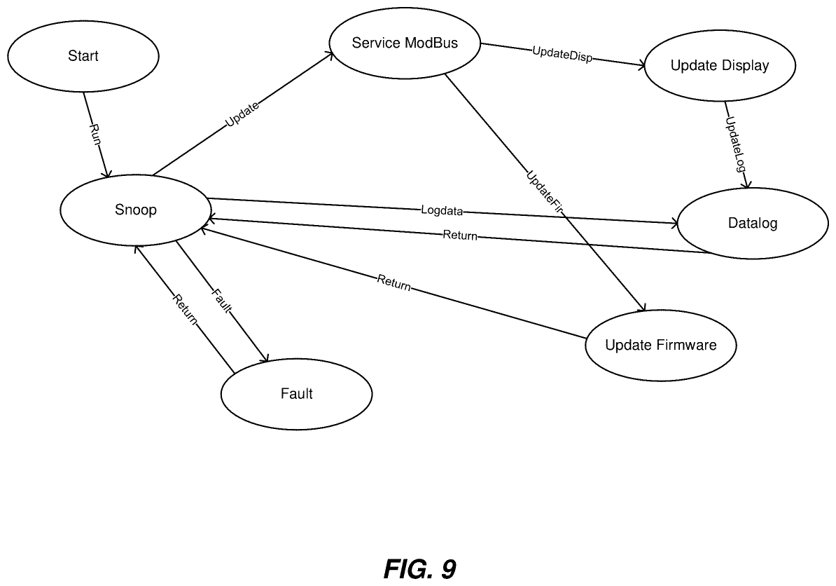

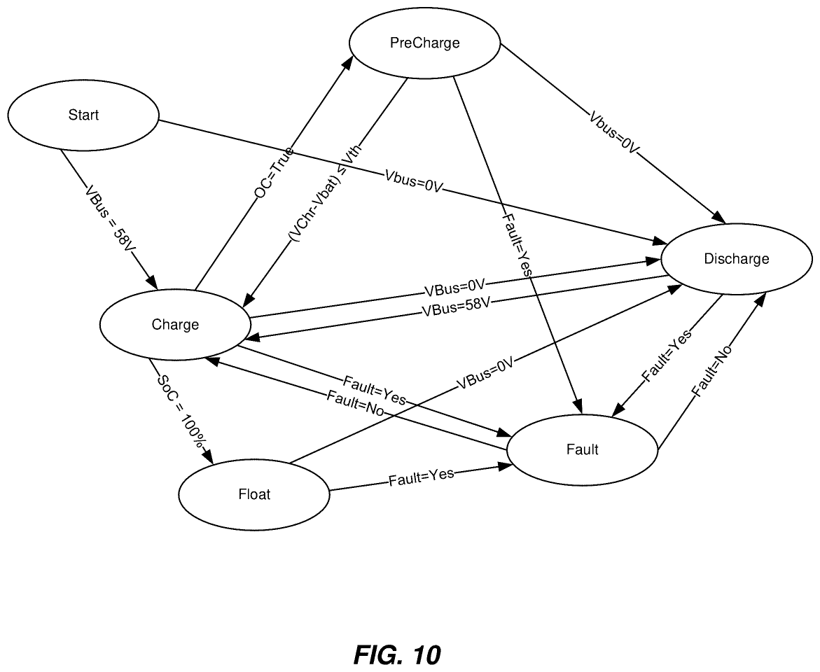

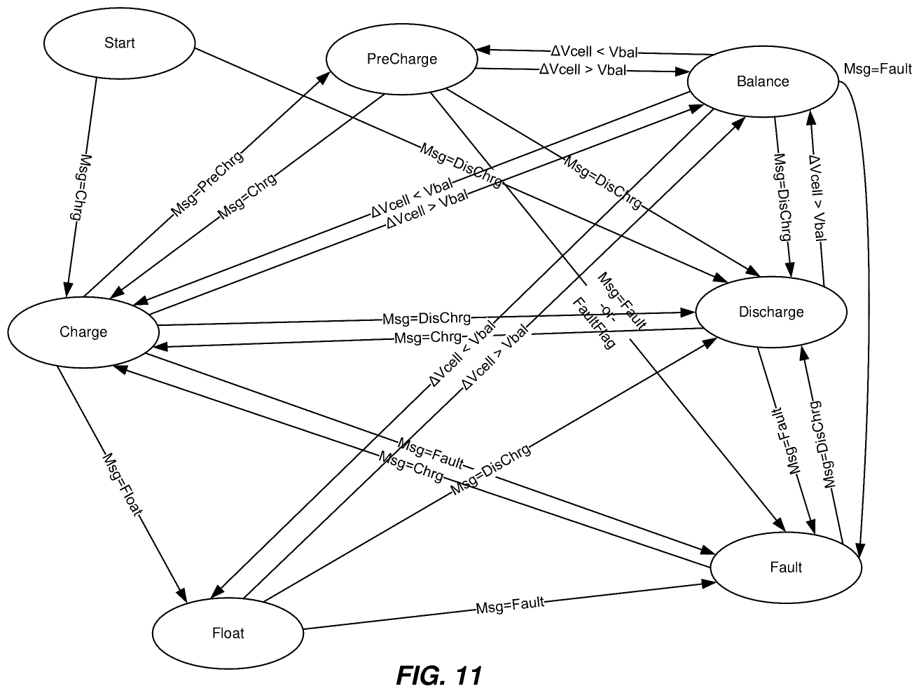

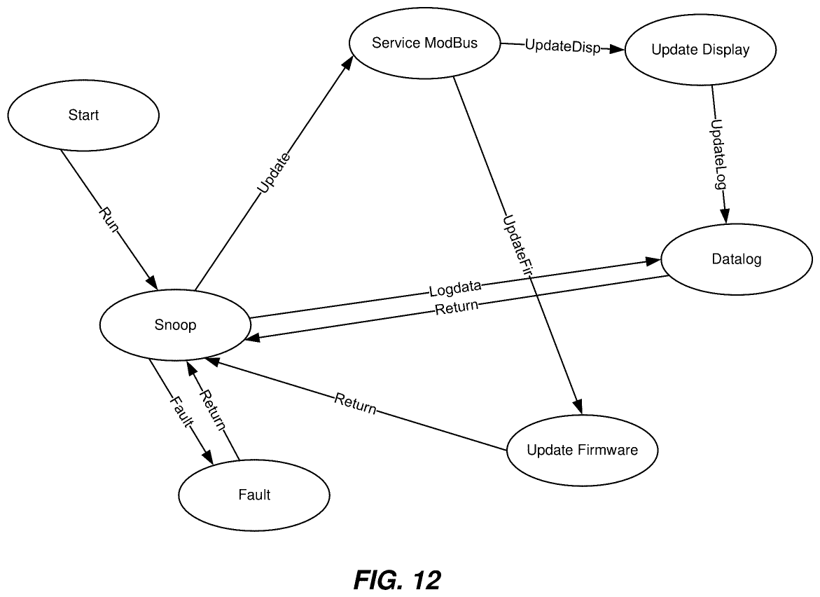

FIG. 6-FIG. 9 First Set with Maintenance Mode

### Protection System->Main Controller

The main controller for a string resides in the protection unit. The protection unit includes a protection board and a housing.

A main controller state machine runs on the protection board. The main controller state machine changes state based on the inputs from the sensors. Following Sensors are used: (a) voltage sensing->sensing the string voltage, pack voltage and the bus voltage; (b) current sensing->sensing a current flowing in and out of the string; (c) temperature sensing->temperature of the modules in the pack, temperature of the board in the pack, temperature of a shunt resistor are monitored.

Based on the sensor information, following protection functions are implemented. Protection function executes when it exceeds the threshold value by opening up a contactor thereby protecting the packs and/or cells. Following are the Protection functions: (a) OV->over voltage during charging; (b) UV->under voltage during discharge; and (c) OC->over current and over temperature. These conditions put the state machine into a fault state. Some of these faults are auto recoverable which may be accomplished in a maintenance state.

In some embodiments, to go to a discharge state, the system monitors the current. When the current is −Ve the state machine transitions to discharge. When the current changes direction from −Ve to +Ve the it transitions to charge.

From any state to fault when Msg=Fault. Float to Balance when Not Balance is True then State M/C transitions to Balance. When the pack gets balanced, then the State M/C transitions to Float. In low power discharge when the pack is determined to be out of balance then the pack is turned ON the pack balancing. Once pack is balanced the it pushes back to the discharge state.

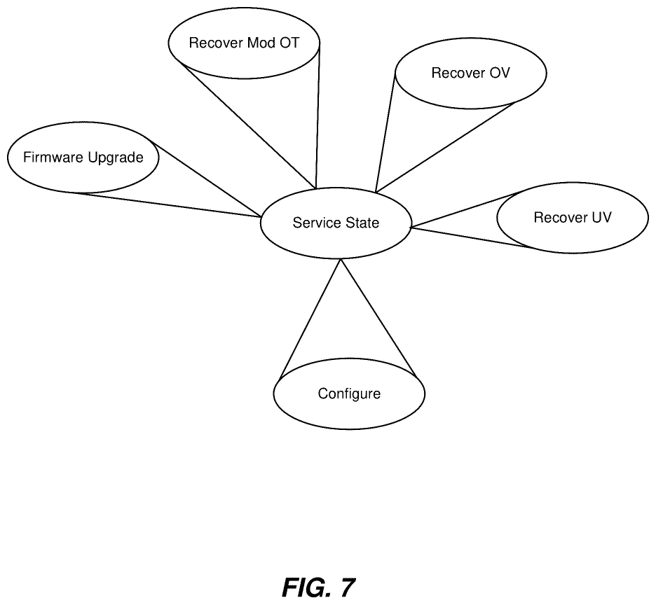

Associated with FIG. 7 is the maintenance mode. Cell overvoltage (OV); entry=when cell OV is reported by a pack follower state machine to the main controller state machine (MCSM). MCSM acknowledges by transitioning from a charge state to a fault state. FAULT state=contactor C4 should close first followed by opening contactor C2.

Since cell OV is a recoverable fault the MCSM transitions from FAULT to MAINTENANCE state. In MAINTENANCE, it will transition to recover OV state. In this Sub state the MCSM will instruct a particular pack to transition to BALANCE state and will request the cell voltage to balance and reach cell V<OVrecovery and/or cellV<Vbal. Once the balance achieves the condition it will transition to the MAINTENANCE state. MCSM now transitions to SERVICE state and clears the FAULT and issues SELF SOFT RESET.

Pack OV: Similar to the preceding—a pack over voltage for a particular pack causes a command to balance all cells in the particular pack. An alternative solution may include a pack balance resistor that may be enabled (e.g., turned ON).

ENTER: when a pack is over voltage greater than a threshold—in this case, when a pack OV>60V.

STRING OV: >600; Vbus OV: When Vbus>600, recovery is possible when a Vbus voltage is less than or equal to 580V.

Under Voltage: Cell UV—may occur when a cell voltage falls below 0.5V; Pack UV—may occur when a pack voltage is less than 32V; String UV—may occur when a string voltage is less than 320V; Recovery—when the Vbus comes back the system will recover through a Softreset.

Module over temperature: In the module over temperature case, the system may wait to naturally cool off and then the System may clear the FAULT and issues a Softreset. An alternative may include a set of fans that may be enabled/turned ON to decrease over temperature. Monitoring of the MODULE temperature occurs by the FOLLOWER state machine.

Firmware upgrade: A firmware upgrade request is provided on the CAN bus to a protection board. The request typically will flow from the interface board or the interface monitor. The protection board may not respond, for example when it is in a DISCHARGE mode. In other STATE, the protection board may trigger a FAULT and then transition to FAULT, to MAINTENANCE, to FIRMWARE SUB state. The follower will follow the MCSM. The Vbus needs to be present.

Configuration: Configuration process may be similar to the FIRMWARE upgrade process. Vbus needs to be present.

### Follower State Machine

Each pack includes cells and a balance board. The Balance board manages the Pack. Follower state machine runs on the Balance board and picks up the state of the Protection board and follows. The Balance is the one that differs from the Main Controller. The Balance board decides to go to Balance state based on the state of the Protection board and the spread of the voltages in the Pack.

Balance board may enter the Fault state and may request the Main Controller to follow and take the System offline.

### Snooping State Machine

Interaction to the outside world is achieved through the Interface board that is housed in the Interface unit. The Snooping state machine running on the Interface board and picks up the data that is running on the CAN bus. The data is decoded and is made available for the customer through the ModBus interface. Paralleling of two or more rack systems is enabled by the Snooping state machine. Snooping state machine monitors data flow and provides permission/authorizes a closure of contactor C2 for any particular rack system.

Each rack system waits in a parallel mode for permission from the Snooping State machine in order to close contactor C2. One condition that enables Snooping state machine to provide permission to close contactor C2 includes a determination that voltages between two rack systems is equal or very close to each other (e.g., within a predetermined threshold—such as +/−5V). Paralleled rack systems operate independently once contactors C2 are closed.

For example, a first rack system may be online and a second rack system is configured to be added in parallel. When the snooping state machine of the second rack system determines that the voltage of the second rack system is within the predetermined threshold, the snooping state machine provides permission for the second rack system to close contactor C2 and add the second rack system the first rack system, in parallel. Additional racks may be added in parallel in similar fashion.

In some embodiments, an emergency power off (EPO) signal may be enabled for each rack system. In case of a condition requiring urgent shutdown of the rack systems, activating this EPO signal brings down the parallel rack system to a fault condition and opens all main contactors C2.

Snooping state machine process CAN data and logs the data in long term memory.

Snooping state machine interacts with the Customer through MODBUS Ethernet port.

Firmware upgrade to Balance board & Protection board happens through the Interface board.

### State Machine Set TWO (No Explicit Maintenance Mode):

The Main controller for the String resides in the Protection unit. Protection unit consist of a Protection board and a housing

### Main Controller State Machine

Main controller state machine runs on the Protection board. Main controller state machine changes state based on the inputs from the Sensors. Following Sensors are used:

Voltage sensing->Sensing the String voltage, Pack voltage and the Bus voltage

Current sensing->Sensing the Current flowing in and out of the String.

Temperature sensing->Temperature of the modules in the Pack, Temperature of the board in the Pack, Temperature of the Shunt resistor are monitored.

Based on the sensor information following Protection functions are implemented. Protection function executes when it exceeds the threshold value by opening up a contactor there by protecting the Packs or cells. Following are the Protection functions.

OV->Over Voltage during charging, UV->Under voltage during discharge, OC->Over Current during Charging, UC->Under current during discharge & OT->Over Temperature.

Main Controller will decide when the String need to be charged with High current or low current based on the status of the Packs in the String. Status of the Pack could be balanced, Pack low voltage (Pack voltage<32V) or Pack fault.

Main Controller communicates to all the Packs through CAN Bus.

### Follower State Machine

Pack contains Cells and a Balance board. The Balance board manages the Pack. Follower state machine runs on the Balance board and picks up the state of the Protection board and follows. The Balance is the one that differs from the Main Controller. The Balance board decides to go to Balance state based on the state of the Protection board and the spread of the voltages in the Pack.

Balance board may enter the Fault state and may request the Main Controller to follow and take the System offline.

### Snooping State Machine

Interaction to the outside world is achieved through the Interface board that is housed in the Interface unit. The Snooping state machine running on the Interface board & picks up the data that is running on the CAN bus. The data is decoded and is made available for the customer through the ModBus interface.

Snooping state machine process CAN data & logs the data in long term memory.

Snooping state machine interacts with the Customer through MODBUS Ethernet port.

Firmware upgrade to Balance board & Protection board happens through the Interface board.

The system and methods above have been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention is not limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A rack controller for a power bridging rack, comprising:
(a) a first section, a protection section managed by a Main Controller State Machine (MCSM);
(b) a second section, a pack management section managed by a Follower State Machine (FSM); and
(c) a third section, an interaction section in communication with the outside world managed by a Snooping State Machine (SSM).

2. The rack controller of claim 1 including an explicit maintenance mode.

3. The rack controller of claim 1 without an explicit maintenance mode.

4. The rack controller of claim 1 wherein said Snooping State Machine is configured to enable two or more rack systems to be connected in parallel.

5. The rack controller of claim 1 disposed in each of a plurality of rack systems, each rack system including a power rail supporting a string of power packs controlled by a contactor C2 wherein said rack systems exchange data, and wherein each said Snooping State Machine, responsive to a set of exchanged data, is configured to authorize a closure of said contactor C2.

6. The rack controller of claim 5 wherein said set of exchanged data includes power rail voltage measurements and wherein said closure is authorized when said power rail voltages are within a predetermined threshold of each other.

7. The rack controller of claim 6 wherein said predetermined threshold is +/−5V.

8. The rack controller of claim 5 wherein said first rack and second rack operate independently of each other after said contactor C2 is closed.

9. The rack controller of claim 5 further comprising a power off signal and wherein one of said state machines, responsive to said power off signal, configures each rack system into a fault state wherein each contactor C2 of each said rack system is opened.
